(19) United States
(12) Patent Application Publication
(10) Pub. No.: US 2014/0178768 A1
(43) Pub. Date: Jun. 26, 2014

(54) ALL SOLID STATE BATTERY AND PRODUCING METHOD THEREFOR

(71) Applicants: Takayuki Uchiyama, Susono-shi (JP); Tomoya Suzuki, Susono-shi (JP)

(72) Inventors: Takayuki Uchiyama, Susono-shi (JP); Tomoya Suzuki, Susono-shi (JP)

(73) Assignee: TOYOTA JIDOSHA KABUSHIKI KAISHA, Toyota-shi, Aichi (JP)

(21) Appl. No.: 14/123,821

(22) PCT Filed: Jul. 10, 2012
(86) PCT No.: PCT/JP2012/067583

§ 371 Date: Dec. 4, 2013

(30) Foreign Application Priority Data
Jul. 20, 2011 (JP) 2011-159242

(51) Int. Cl. H01M 10/0564; H01M 4/1391

(52) U.S. Cl. CPC H01M 10/0564; H01M 4/1391
USPC 429/304; 427/126.3

(57) ABSTRACT

The present invention provides an all solid state battery for inhibiting interface resistance between a cathode active material and a solid electrolyte material. The invention solves the problem by providing a solid state battery comprising a cathode active material layer, an anode active material layer and a solid electrolyte layer formed between the cathode active material layer and the anode active material layer, wherein at least one said cathode active material layer and solid electrolyte layer contains a sulfide solid electrolyte material, a reaction inhibition portion containing a first ion conductor and a second ion conductor formed on the surface of the cathode active material, the first ion conductor is a lithium compound with ion conductance of 1.0×10⁻⁷ S/cm or more at normal temperature, and the second ion conductor is an Li-containing compound with polyanion structural portion having one of B, Si, P, Ti, Zr, Al and W.

### TECHNICAL FIELD

The present invention relates to an all solid state battery capable of inhibiting interface resistance between a cathode active material and a sulfide solid electrolyte material from increasing with time.

### BACKGROUND ART

In accordance with a rapid spread of information relevant apparatuses and communication apparatuses such as a personal computer, a video camera and a portable telephone in recent years, the development of a battery to be utilized as a power source thereof has been emphasized. The development of a high-output and high-capacity battery for an electric automobile or a hybrid automobile has been advanced also in the automobile industry. A lithium battery has been presently noticed from the viewpoint of a high energy density among various kinds of batteries.

Liquid electrolyte containing a flammable organic solvent is used for a presently commercialized lithium battery, so that the installation of a safety device for inhibiting temperature rise during a short circuit and the improvement in structure and material for preventing the short circuit are necessary therefor. On the contrary, a lithium battery all-solidified by replacing the liquid electrolyte with a solid electrolyte layer is conceived to intend the simplification of the safety device and be excellent in production cost and productivity for the reason that the flammable organic solvent is not used in the battery.

The intention of improving performance of an all solid state battery while noticing the interface between a cathode active material and a solid electrolyte material has been conventionally attempted in the field of such an all solid state battery. For example, in Non-Patent Literature 1, a material such that the surface of LiCoO₂ as a cathode active material is coated with LiNbO₃ is disclosed. This technique intends to achieve higher output of a battery by coating the surface of LiCoO₂ with LiNbO₃ to decrease interface resistance between LiCoO₂ and a solid electrolyte material.

Also, in Patent Literature 1, a cathode active material coated with a resistive layer formation inhibition coat layer such that the surface of a cathode active material is coated with a resistive layer formation inhibition coat layer is disclosed. This intends to inhibit a high resistive section from being formed by a reaction between a cathode active material and a solid electrolyte material, and the cathode active material from being eroded by growth of the high resistive section. In addition, in Patent Literature 2, a material for a cathode active material such that a cathode active material is coated with LiNbO₃ to regulate a coating state with measurement by XPS is disclosed. This intends to inhibit interface resistance between an oxide cathode active material and a solid electrolyte material from increasing at high temperature by uniformizing the thickness of LiNbO₃ for coating.

### CITATION LIST

### Patent Literatures

Patent Literature 1: Japanese Patent Application Publication (JP-A) No. 2009-266728

Patent Literature 2: JP-A No. 2010-170715

### Non-Patent Literature

Non-Patent Literature 1: Narumi Ohta et al., “LiNbO₃-coated LiCoO₂ as cathode material for all solid-state lithium secondary batteries”, Electrochemistry Communications 9 (2007), 1486-1490

### SUMMARY OF INVENTION

### Technical Problem

As described in the above-mentioned Patent Literature 1, the formation of the resistive layer formation inhibition coat layer (a reaction inhibition portion) on the surface of the cathode active material allows interface resistance between the cathode active material and the solid electrolyte material to be decreased. The reason therefor is conceived to be that the formation of the reaction inhibition portion on the surface of the cathode active material allows a high resistive layer to be inhibited from occurring by a reaction between the cathode active material and the solid electrolyte material (particularly a sulfide solid electrolyte material). However, the problem is that the formation of the reaction inhibition portion deteriorates ion conductivity to decrease output characteristics of an all solid state battery using a cathode active material layer containing the cathode active material on whose surface the reaction inhibition portion is formed, and it is desired to form the reaction inhibition portion composed of a material excellent in ion conductivity.

For example, LiNbO₃ exhibits a Li ion conductivity of approximately 1.0×10⁻⁷ S/cm or more at normal temperature. The cathode active material provided with the reaction inhibition portion composed of such a material has the advantage such as to be excellent in Li ion conductivity, and allows interface resistance between the cathode active material and the solid electrolyte material to be decreased at the initial stage in producing the all solid state battery. However, the problem is that interface resistance increases with time.

The present invention has been made in view of the above-mentioned actual circumstances, and the main object thereof is to provide an all solid state battery capable of inhibiting interface resistance between a cathode active material and a solid electrolyte material from increasing with time.

### Solution to Problem

In order to achieve the above-mentioned object, the present invention provides an all solid state battery comprising a cathode active material layer containing a cathode active material, an anode active material layer containing an anode active material, and a solid electrolyte layer formed between the above-mentioned cathode active material layer and the above-mentioned anode active material layer, wherein at least one of the above-mentioned cathode active material layer and the above-mentioned solid electrolyte layer contains a sulfide solid electrolyte material, a reaction inhibition portion containing a first lithium ion conductor and a second lithium ion conductor is formed on the surface of the above-mentioned cathode active material, the above-mentioned first lithium ion conductor is an Li-containing compound with a lithium ion conductance of 1.0×10⁻⁷ S/cm or more at normal temperature, and the above-mentioned second lithium ion conductor is an Li-containing compound provided with a polyanion structural portion having at least one of B, Si, P, Ti, Zr, Al and W.

According to the present invention, the disposition of the reaction inhibition portion containing the second lithium ion conductor with high electrochemical stability in addition to the first lithium ion conductor with favorable Li ion conductivity on the surface of the cathode active material allows interface resistance between the cathode active material and the sulfide solid electrolyte material to be inhibited from increasing with time. Thus, the all solid state battery excellent in Li ion conductivity and durability may be obtained.

In the above-mentioned invention, the above-mentioned first lithium ion conductor is preferably LiNbO₃.

Also, the present invention provides a method for producing the above-mentioned all solid state battery, comprising steps of: an inside layer forming step of forming an inside layer by coating and drying one coating liquid of a first precursor coating liquid containing a raw material for the above-mentioned first lithium ion conductor and a second precursor coating liquid containing a raw material for the above-mentioned second lithium ion conductor on the surface of the above-mentioned cathode active material; an outside layer forming step of forming an outside layer by coating and drying the other coating liquid of the above-mentioned first precursor coating liquid and the above-mentioned second precursor coating liquid on the surface of the above-mentioned inside layer; and a heat-treating step of heat-treating the above-mentioned inside layer and the above-mentioned outside layer to form the above-mentioned reaction inhibition portion.

According to the present invention, the above-mentioned coating liquid is coated on the surface of the cathode active material or on the inside layer, and dried so that the coating liquids do not react with each other to thereby form each of the inside layer and the outside layer, and thereafter both of the layers are heat-treated together, so that the reaction inhibition portion in which the first lithium ion conductor and the second lithium ion conductor are uniformly dispersed may be formed simply and easily. Thus, interface resistance between the cathode active material and the sulfide solid electrolyte material may be inhibited from increasing with time, and the all solid state battery excellent in Li ion conductivity and durability may be produced simply and easily.

In the above-mentioned invention, the above-mentioned first lithium ion conductor is preferably LiNbO₃.

### Advantageous Effects of Invention

The present invention produces the effect such as to allow interface resistance between a cathode active material and a sulfide solid electrolyte material to be inhibited from increasing with time.

### BRIEF DESCRIPTION OF DRAWINGS

FIGS. 1A and B are explanatory views showing an example of a power generating element of an all solid state battery of the present invention.

FIG. 2 is a flow chart showing an example of a producing method of an all solid state battery of the present invention.

FIGS. 3A and B are schematic cross-sectional views showing an example of an all solid state battery of the present invention.

FIG. 4 is a TEM image of a cross section of a cathode active material of an all solid state battery obtained in Example.

FIG. 5 is a graph showing a change of interface resistance under a 60-° C.-storage environment of an all solid state battery obtained in Example and Comparative Example.

### DESCRIPTION OF EMBODIMENTS

An all solid state battery and a method for producing the all solid state battery of the present invention are hereinafter described in detail.

A. All Solid State Battery

First, an all solid state battery of the present invention is described. The all solid state battery of the present invention is an all solid state battery comprising a cathode active material layer containing a cathode active material, an anode active material layer containing an anode active material, and a solid electrolyte layer formed between the above-mentioned cathode active material layer and the above-mentioned anode active material layer, wherein at least one of the above-mentioned cathode active material layer and the above-mentioned solid electrolyte layer contains a sulfide solid electrolyte material, a reaction inhibition portion containing a first lithium ion conductor and a second lithium ion conductor is formed on the surface of the above-mentioned cathode active material, the above-mentioned first lithium ion conductor is an Li-containing compound with a lithium ion conductance of 1.0×10⁻⁷ S/cm or more at normal temperature, and the above-mentioned second lithium ion conductor is an Li-containing compound provided with a polyanion structural portion having at least one of B, Si, P, Ti, Zr, Al and W.

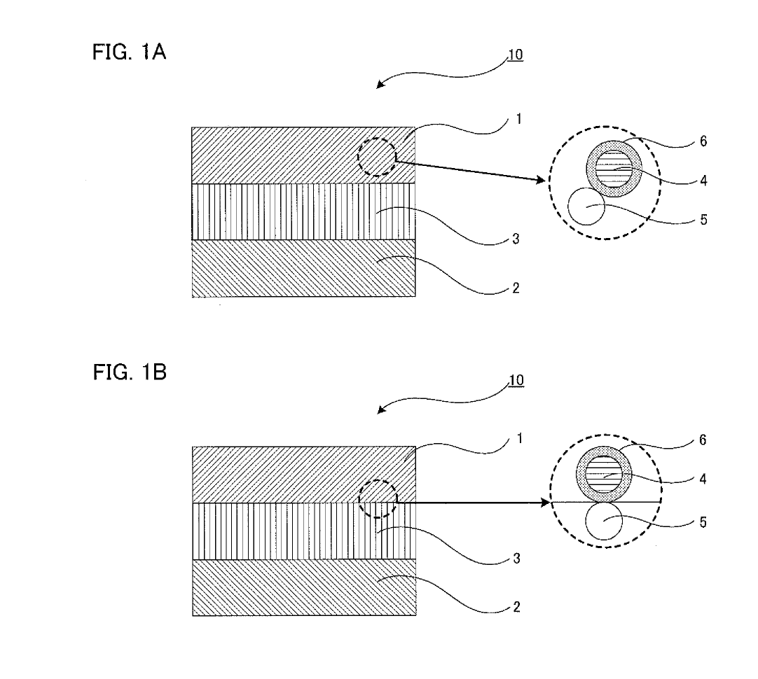

FIGS. 1A and 1B are explanatory views showing an example of a power generating element of the all solid state battery of the present invention. A power generating element 10 of the all solid state battery exemplified in FIGS. 1A and 1B has a cathode active material layer 1, an anode active material layer 2, and a solid electrolyte layer 3 formed between the cathode active material layer 1 and the anode active material layer 2. Also, the cathode active material layer 1 has a cathode active material 4 on whose surface a reaction inhibition portion 6 is formed. In addition, a sulfide solid electrolyte material 5 is contained in at least one of the cathode active material layer 1 and the solid electrolyte layer 3, and contacts with the cathode active material 4 through the reaction inhibition portion 6. Thus, the sulfide solid electrolyte material 5 may be contained in the cathode active material layer 1 as shown in FIG. 1A, contained in the solid electrolyte layer 3 as shown in FIG. 1B, or contained in both the cathode active material layer 1 and the solid electrolyte layer 3 though not shown in the figures.

The present invention allows the reaction inhibition portion with high electrochemical stability as compared with a conventional reaction inhibition portion formed from only a niobium oxide (such as LiNbO₃) exhibiting favorable Li ion conductivity by reason of having the reaction inhibition portion, in which the second lithium ion conductor with high electrochemical stability in addition to the first lithium ion conductor with favorable Li ion conductivity are contained, on the surface of the cathode active material. Thus, the structure of the reaction inhibition portion can be inhibited from changing in contacting with the sulfide solid electrolyte material, so that interface resistance between the cathode active material and the sulfide solid electrolyte material can be inhibited from increasing with time. Incidentally, the above-mentioned second lithium ion conductor is provided with a polyanion structural portion having at least one of B, Si, P, Ti, Zr, Al and W, and is high in electrochemical stability as described later.

The all solid state battery of the present invention is hereinafter described in each constitution.

1. Cathode Active Material Layer

First, the cathode active material layer in the present invention is described. The cathode active material layer used for the present invention contains at least the cathode active material. Also, the cathode active material layer in the present invention may contain at least one of a solid electrolyte material and a conductive material as required, and may particularly preferably a sulfide solid electrolyte material above all. The reason therefor is to allow ion conductivity of the cathode active material layer to be improved.

(1) Cathode Active Material

The cathode active material used for the present invention is described. The cathode active material used for the present invention is not particularly limited if the charge and discharge electric potential thereof is a noble electric potential as compared with the charge and discharge electric potential of the anode active material contained in the after-mentioned anode active material layer. Preferable examples of such a cathode active material include an oxide cathode active material from the viewpoint of reacting with the after-mentioned sulfide solid electrolyte material to form a high resistive layer. Also, the use of the oxide cathode active material allows the all solid state battery with high energy density.

Examples of the oxide cathode active material used for the present invention include a cathode active material represented by a general formula LiₓM_{y}O_{z} (M is a transition metallic element, x=0.02 to 2.2, y=1 to 2 and z=1.4 to 4). In the above-mentioned general formula, M is preferably at least one kind selected from the group consisting of Co, Mn, Ni, V, Fe and Si, and more preferably at least one kind selected from the group consisting of Co, Ni and Mn. Also, a cathode active material represented by a general formula Li₁₊ₓMn_{2-x-y}M_{y}O₄ (M=at least one kind selected from Al, Mg, Co, Fe, Ni and Zn, 0≦x≦1, 0≦y≦2, 0≦x+y≦2) may be used as the oxide cathode active material. Specific examples of such an oxide cathode active material include LiCoO₂, LiMnO₂, LiNiO₂, LiVO₂, LiNi_{1/3}CO_{1/3}Mn_{1/3}O₂, LiMn₂O₄ and Li(Mn_{1.5}Ni_{0.5})O₄. Also, examples of other oxide cathode active materials include Li₂FeSiO₄ and Li₂MnSiO₄.

Examples of the shape of the cathode active material include a particulate shape such as a perfectly spherical shape and an elliptically spherical shape, and a thin-film shape, and preferably a particulate shape, above all. Also, in the case where the cathode active material is in a particulate shape, the average particle diameter thereof is, for example, preferably within a range of 0.1 μm to 50 μm. Also, the content of the cathode active material in the cathode active material layer is, for example, preferably within a range of 10% by mass to 99% by mass, and more preferably within a range of 20% by mass to 90% by mass.

(2) Reaction Inhibition Portion

The reaction inhibition portion in the present invention is described. The reaction inhibition portion used for the present invention is formed on the surface of the above-mentioned cathode active material, and contains the first lithium ion conductor and the second lithium ion conductor. Also, the above-mentioned first lithium ion conductor composing the reaction inhibition portion is an Li-containing compound with a lithium ion conductance of 1.0×10⁻⁷ S/cm or more at normal temperature, and the above-mentioned second lithium ion conductor is an Li-containing compound provided with a polyanion structural portion having at least one of B, Si, P, Ti, Zr, Al and W. The reaction inhibition portion has the function of inhibiting a reaction between the cathode active material and the sulfide solid electrolyte material, which is produced during the use of the all solid state battery. In the present invention, the reaction inhibition portion is composed of the first lithium ion conductor and the second lithium ion conductor as described above, so that electrochemical stability is so high as compared with a conventional reaction inhibition portion formed from only a niobium oxide (such as LiNbO₃) as to allow interface resistance to be inhibited from increasing with time.

Each constitution of the reaction inhibition portion is hereinafter described.

(i) First Lithium Ion Conductor

The first lithium ion conductor in the present invention is ordinarily a Li-containing compound with a lithium ion conductance of 1.0×10⁻⁷ S/cm or more at normal temperature. With regard to the first lithium ion conductor, the lithium ion conductance at normal temperature is more preferably 1.0×10⁻⁶ S/cm or more, above all. The first lithium ion conductor exhibits a lithium ion conductance in the above-mentioned range, so that Li ion conductivity may be inhibited from deteriorating in forming the reaction inhibition portion on the surface of the cathode active material. Thus, output characteristics may be inhibited from decreasing in the all solid state battery using the cathode active material layer containing the cathode active material on whose surface the reaction inhibition portion is formed. Incidentally, a measuring method for lithium ion conductance is not particularly limited if the method is such that the lithium ion conductance at normal temperature of the first lithium ion conductor in the present invention may be measured, but examples thereof include a measuring method by using an alternating current impedance method.

The first lithium ion conductor is not particularly limited if the first lithium ion conductor is such as to have a lithium ion conductance in the above-mentioned range, but examples thereof include an Li-containing oxide such as LiNbO₃ and LiTaO₃, and a NASICON-type phosphoric acid compound. Above all, the Li-containing oxide is preferable and LiNbO₃ is particularly preferable. The reason therefor is to allow the effect of the present invention to be further performed. Incidentally, examples of the above-mentioned NASICON-type phosphoric acid compound include Li₁₊ₓAlₓTi₂₋ₓ(PO₄)₃ (0≦x≦2) (LATP) and Li₁₊ₓAlₓGe₂₋ₓ(PO₄)₃ (0≦x≦2) (LAGP). In LATP, in the above-mentioned general formula, the range of “x” may be 0 or more, preferably more than 0 above all, and particularly preferably 0.3 or more. On the other hand, the range of “x” may be 2 or less, preferably 1.7 or less above all, and particularly preferably 1 or less. In particular, in the present invention, Li_{1.5}Al_{0.5}Ti_{1.5}(PO₄)₃ is preferable. Also, in LAGP, in the above-mentioned general formula, the range of “x” may be 0 or more, preferably more than 0 above all, and particularly preferably 0.3 or more. On the other hand, the range of “x” may be 2 or less, preferably 1.7 or less above all, and particularly preferably 1 or less. In particular, in the present invention, Li_{1.5}Al_{0.5}Ge_{1.5}(PO₄)₃ may be appropriately used.

Here, in the case where the reaction inhibition portion contains LiNbO₃, it is conceived that the structure of LiNbO₃ formed on the surface of the cathode active material changes with time in a conventionally used reaction inhibition portion composed of only LiNbO₃ to thereby cause interface resistance to increase with time. That is to say, it is conceived that the bond between a niobium element and an oxygen element composing LiNbO₃ is so weak that LiNbO₃ reacts with the sulfide solid electrolyte material in contacting therewith.

On the contrary, in the present invention, the reaction inhibition portion is formed by blending the second lithium ion conductor as a material having an element bonded strongly to an oxygen element except for LiNbO₃ as the first lithium ion conductor, so that interface resistance between the cathode active material and the sulfide solid electrolyte material may be inhibited from increasing with time in producing the all solid state battery.

(ii) Second Lithium Ion Conductor

Next, the second lithium ion conductor in the present invention is ordinarily a Li-containing compound provided with a polyanion structural portion having at least one of B, Si, P, Ti, Zr, Al and W. The second lithium ion conductor is so high in electrochemical stability that the reaction inhibition portion capable of inhibiting structural change caused in contacting with the sulfide solid electrolyte material may be obtained by being contained with the first lithium ion conductor, as described above. The reason why the second lithium ion conductor is high in electrochemical stability is as follows.

That is to say, in the case where the second lithium ion conductor is an Li-containing compound provided with a polyanion structural portion having at least one of B, Si, P, Al and W, electronegativity of each element of B, Si, P, Al and W becomes larger as compared with electronegativity (1.60) of Nb contained in a compound used for a conventional reaction inhibition portion, such as a niobium oxide, in electronegativity of Pauling. Thus, a difference from electronegativity (3.44) of an oxygen element becomes so smaller as compared with Nb that more stable covalent bond may be formed. As a result, electrochemical stability becomes higher. Also, in the case where the second lithium ion conductor is a Li-containing compound provided with a polyanion structural portion having at least either one of Ti and Zr, so excellent corrosion resistance is exhibited that electrochemical stability becomes higher. This results from Ti and Zr as an element which is easily made into passivity such that an oxide film is formed on the surface thereof, the so-called valve metal. Thus, it is conceived that a Li-containing compound provided with a polyanion structural portion having these metals exhibits so high corrosion resistance that electrochemical stability becomes higher.

The second lithium ion conductor in the present invention is not particularly limited if the second lithium ion conductor is such as to have a polyanion structural portion comprising at least one kind of element among the above-mentioned elements and plural oxygen elements, but examples thereof include Li₃BO₃, LiBO₂, Li₄SiO₄, Li₂Si₂O₃, Li₃PO₄, LiPO₃, Li₂Ti₂O₅, Li₂Ti₂O₃, Li₄Ti₅O₁₂, Li₂ZrO₃, LiAlO₂, or a mixture thereof.

(iii) Reaction Inhibition Portion

The ratio between the first lithium ion conductor and the second lithium ion conductor contained in the reaction inhibition portion in the present invention is properly determined in accordance with an intended all solid state battery. For example, in the case of regarding the first lithium ion conductor as 100 parts by mol, the second lithium ion conductor is preferably within a range of 1 part by mol to 200 parts by mol, more preferably within a range of 50 parts by mol to 150 parts by mol, and particularly preferably within a range of 80 parts by mol to 120 parts by mol. The reason therefor is that the case where the ratio of the first lithium ion conductor to the second lithium ion conductor is too large brings a possibility of reacting with the sulfide solid electrolyte material in contacting therewith to increase interface resistance with time. On the other hand, the reason therefor is that the case where the ratio of the first lithium ion conductor to the second lithium ion conductor is too small brings a possibility of deteriorating lithium ion conductivity. Incidentally, the composition of the reaction inhibition portion in the present invention may be confirmed by X-ray photoelectron spectroscopy (XPS) measurement or Raman spectroscopy measurement.

The form of the reaction inhibition portion in the present invention is not particularly limited if the reaction inhibition portion is formed on the surface of the above-mentioned cathode active material. For example, as shown in FIGS. 1A and 15, in the case where the shape of the above-mentioned cathode active material is particulate, the form of the reaction inhibition portion is preferably a form such as to cover the surface of the cathode active material. Also, the reaction inhibition portion preferably covers more areas of the cathode active material, and the specific coverage factor is preferably 50% or more, and more preferably 80% or more. Also, the whole surface of the cathode active material may be covered. Incidentally, examples of a measuring method for the coverage factor of the reaction inhibition portion include transmission electron microscope (TEM) and X-ray photoelectron spectroscopy (XPS).

Also, the thickness of the reaction inhibition portion in the present invention is not particularly limited if the thickness is such that the cathode active material and the sulfide solid electrolyte material do not react, but is, for example, preferably within a range of 1 nm to 500 nm, and more preferably within a range of 2 nm to 100 nm. The reason therefor is that the case where the thickness of the above-mentioned reaction inhibition portion is less than the above-mentioned range brings a possibility that the cathode active material and the sulfide solid electrolyte material react. On the other hand, the reason therefor is that the case where the thickness of the above-mentioned reaction inhibition portion exceeds the above-mentioned range brings a possibility of deteriorating ion conductivity. Incidentally, examples of a measuring method for the thickness of the reaction inhibition portion include a method by using transmission electron microscope (TEM).

A forming method for the reaction inhibition portion in the present invention is not particularly limited if the method is such as to allow the reaction inhibition portion as described above to be formed. Examples of the forming method for the reaction inhibition portion include a method for making the cathode active material into a tumbling flow state to coat and dry a coating liquid containing a forming material for the reaction inhibition portion, in the case where the shape of the cathode active material is particulate. Also, in the case where the shape of the cathode active material is a thin film, examples thereof include a method for coating and drying a coating liquid containing a forming material for the reaction inhibition portion on the cathode active material. In particular, in the present invention, the method described in the item of the after-mentioned “B. Producing method for all solid state battery” may be appropriately used.

(3) Sulfide Solid Electrolyte Material

The cathode active material layer in the present invention preferably contains the sulfide solid electrolyte material. The reason therefor is to allow ion conductivity of the cathode active material layer to be improved. The sulfide solid electrolyte material is high in reactivity so as to react easily with the above-mentioned cathode active material and form a high resistive layer easily at an interface with the cathode active material. On the contrary, in the present invention, the formation of the above-mentioned reaction inhibition portion on the surface of the cathode active material allows interface resistance between the cathode active material and the sulfide solid electrolyte material to be effectively inhibited from increasing with time.

Examples of the sulfide solid electrolyte material include Li₂S—P₂S₅, Li₂S—P₂S₅—LiI, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (“m” and “n” are positive numbers, and Z is any of Ge, Zn and Ga) , Li₂S—GeS₂, Li₂S—SiS₂—Li₃PO₄, and Li₂S—SiS₂—LiₓMO_{y} (“x” and “y” are positive numbers; M is any of P, Si, Ge, B, Al, Ga and In). Incidentally, the description of the above-mentioned “Li₂S—P₂S₅” signifies the sulfide solid electrolyte material obtained by using a raw material composition containing Li₂S and P₂S₅, and other descriptions signify similarly.

Also, in the case where the sulfide solid electrolyte material is obtained by using a raw material composition containing Li₂S and P₂S₅, the ratio of Li₂S to the total of Li₂S and P₂S₅ is, for example, preferably within a range of 70 mol % to 80 mol %, more preferably within a range of 72 mol % to 78 mol %, and far more preferably within a range of 74 mol % to 76 mol %. The reason therefor is to allow the sulfide solid electrolyte material having an ortho-composition or a composition in the neighborhood of it and allow the sulfide solid electrolyte material with high chemical stability. Here, ortho generally signifies oxo acid which is the highest in degree of hydration among oxo acids obtained by hydrating the same oxide. In the present invention, a crystal composition to which Li₂S is added most among sulfides is called an ortho-composition. Li₃PS₄ corresponds to the ortho-composition in the Li₂S—P₂S₅ system. In the case of an Li₂S—P₂S₅-based sulfide solid electrolyte material, the ratio of Li₂S and P₂S₅ such as to allow the ortho-composition is Li₂S:P₂S₅=75:25 on a molar basis. Incidentally, also in the case of using Al₂S₃ or B₂S₃ instead of P₂S₅ in the above-mentioned raw material composition, the preferable range is the same. Li₃AlS₃ corresponds to the ortho-composition in the Li₂S—Al₂S₃ system and Li₃BS₃ corresponds to the ortho-composition in the Li₂S—B₂S₃ system.

Also, in the case where the sulfide solid electrolyte material is obtained by using a raw material composition containing Li₂S and SiS₂, the ratio of Li₂S to the total of Li₂S and SiS₂ is, for example, preferably within a range of 60 mol % to 72 mol %, more preferably within a range of 62 mol % to 70 mol %, and far more preferably within a range of 64 mol % to 68 mol %. The reason therefor is to allow the sulfide solid electrolyte material having an ortho-composition or a composition in the neighborhood of it and allow the sulfide solid electrolyte material with high chemical stability. Li₄SiS₄ corresponds to the ortho-composition in the Li₂S—SiS₂ system. In the case of an Li₂S—SiS₂-based sulfide solid electrolyte material, the ratio of Li₂S and SiS₂ such as to allow the ortho-composition is Li₂S:SiS₂=66.7:33.3 on a molar basis. Incidentally, also in the case of using GeS₂ instead of SiS₂ in the above-mentioned raw material composition, the preferable range is the same. Li₄GeS₄ corresponds to the ortho-composition in the Li₂S-GeS₂ system.

Also, in the case where the sulfide solid electrolyte material is obtained by using a raw material composition containing LiX (X=Cl, Br and I), the ratio of LiX is, for example, preferably within a range of 1 mol % to 60 mol %, more preferably within a range of 5 mol % to 50 mol %, and far more preferably within a range of 10 mol % to 40 mol %. Also, in the case where the sulfide solid electrolyte material is obtained by using a raw material composition containing Li₂O, the ratio of Li₂O is, for example, preferably within a range of 1 mol % to 25 mol %, and more preferably within a range of 3 mol % to 15 mol %.

Also, the sulfide solid electrolyte material may be sulfide glass, crystallized sulfide glass, or a crystalline material obtained by a solid phase method. Incidentally, the sulfide glass may be obtained by performing mechanical milling (such as ball mill) for a raw material composition, for example. Also, the crystallized sulfide glass may be obtained by heat-treating the sulfide glass at a temperature of crystallization temperature or higher, for example. Also, the lithium ion conductance at normal temperature of the sulfide solid electrolyte material is, for example, preferably 1×10⁻⁵ S/cm or more, and more preferably 1×10⁻⁴ S/cm or more.

Examples of the shape of the sulfide solid electrolyte material in the present invention include a particulate shape such as a perfectly spherical shape and an elliptically spherical shape, and a thin-film shape. In the case where the sulfide solid electrolyte material is in the above-mentioned particulate shape, the average particle diameter (D₅₀) thereof is not particularly limited but preferably 40 μm or less, more preferably 20 μm or less, and far more preferably 10 μm or less. The reason therefor is to easily intend to improve filling factor in the cathode active material layer. On the other hand, the above-mentioned average particle diameter is preferably 0.01 μm or more, and more preferably 0.1 μm or more. Incidentally, the above-mentioned average particle diameter may be determined by a granulometer, for example.

(4) Cathode Active Material Layer

The cathode active material layer in the present invention may further contain at least one of a conductive material and a binder except for the above-mentioned cathode active material, reaction inhibition portion and sulfide solid electrolyte material. Examples of the conductive material include acetylene black, Ketjen Black and carbon fiber. Examples of the binder include fluorine-containing binders such as PTFE and PVDF. The thickness of the above-mentioned cathode active material layer varies with the constitution of an intended all solid state battery, and is preferably within a range of 0.1 μm to 1000 μm, for example.

2. Solid Electrolyte Layer

Next, the solid electrolyte layer in the present invention is described. The solid electrolyte layer in the present invention is a layer formed between the cathode active material layer and the anode active material layer, and a layer containing at least a solid electrolyte material. As described above, in the case where the cathode active material layer contains the sulfide solid electrolyte material, the solid electrolyte material contained in the solid electrolyte layer is not particularly limited if the material has lithium ion conductivity, but may be the sulfide solid electrolyte material or a solid electrolyte material except therefor. On the other hand, in the case where the cathode active material layer does not contain the sulfide solid electrolyte material, the solid electrolyte layer contains the sulfide solid electrolyte material. In particular, in the present invention, both the cathode active material layer and the solid electrolyte layer preferably contain the sulfide solid electrolyte material. The reason therefor is to allow the effect of the present invention to be sufficiently produced. Also, the solid electrolyte material used for the solid electrolyte layer is preferably composed of only the sulfide solid electrolyte material.

Incidentally, the sulfide solid electrolyte material is the same as the contents described in the item of the above-mentioned “1. Cathode active material layer”; therefore, the description herein is omitted. Also, the same material as a solid electrolyte material used for a general all solid state battery may be used for a solid electrolyte material except the sulfide solid electrolyte material.

The thickness of the solid electrolyte layer in the present invention is, for example, preferably within a range of 0.1 μm to 1000 μm, and more preferably within a range of 0.1 μm to 300 μm.

3. Anode Active Material Layer

Next, the anode active material layer in the present invention is described. The anode active material layer in the present invention is a layer containing at least the anode active material, and may contain at least one of a solid electrolyte material and a conductive material as required. The anode active material is not particularly limited if the charge and discharge electric potential thereof is a base electric potential as compared with the charge and discharge electric potential of the cathode active material contained in the above-mentioned cathode active material layer, but examples thereof include a metal active material and a carbon active material. Examples of the metal active material include Li alloy, In, Al, Si, and Sn. On the other hand, examples of the carbon active material include mesocarbon microbeads (MCMB), high orientation property graphite (HOPG), hard carbon and soft carbon. Incidentally, the solid electrolyte material and the conductive material used for the anode active material layer are the same as the above-mentioned case in the cathode active material layer. Also, the thickness of the anode active material layer is within a range of 0.1 μm to 1000 μm, for example.

4. Other Constitutions

The all solid state battery of the present invention has at least the above-mentioned cathode active material layer, solid electrolyte layer and anode active material layer, ordinarily further having a cathode current collector for collecting the cathode active material layer and an anode current collector for collecting the anode active material layer. Examples of a material for the cathode current collector include SUS, aluminum, nickel, iron, titanium and carbon, and preferably SUS among them. On the other hand, examples of a material for the anode current collector include SUS, copper, nickel and carbon, and preferably SUS among them. Also, the thickness and shape of the cathode current collector and the anode current collector are preferably selected properly in accordance with uses of the all solid state battery. Also, a battery case used for a general all solid state battery may be used for a battery case used for the present invention, and examples thereof include a battery case made of SUS. Also, the all solid state battery of the present invention may be such that a power generating element is formed inside an insulating ring.

5. All Solid State Battery

The all solid state battery of the present invention may be a primary battery or a secondary battery, and preferably be a secondary battery among them. The reason therefor is to be repeatedly charged and discharged and be useful as a car-mounted battery, for example. Also, examples of the shape of the all solid state battery of the present invention include a coin shape, a laminate shape, a cylindrical shape and a rectangular shape. A producing method for the all solid state battery of the present invention is not particularly limited if the method is such as to allow the above-mentioned all solid state battery, but the after-mentioned producing method for the all solid state battery may be appropriately used.

B. Producing Method for All Solid State Battery

Next, a method for producing the all solid state battery of the present invention is described. The method for producing the all solid state battery of the present invention is a method for producing the above-mentioned all solid state battery, comprising steps of: an inside layer forming step of forming an inside layer by coating and drying one coating liquid of a first precursor coating liquid containing a raw material for the above-mentioned first lithium ion conductor and a second precursor coating liquid containing a raw material for the above-mentioned second lithium ion conductor on the surface of the above-mentioned cathode active material; an outside layer forming step of forming an outside layer by coating and drying the other coating liquid of the above-mentioned first precursor coating liquid and the above-mentioned second precursor coating liquid on the surface of the above-mentioned inside layer; and a heat-treating step of heat-treating the above-mentioned inside layer and the above-mentioned outside layer to form the above-mentioned reaction inhibition portion.

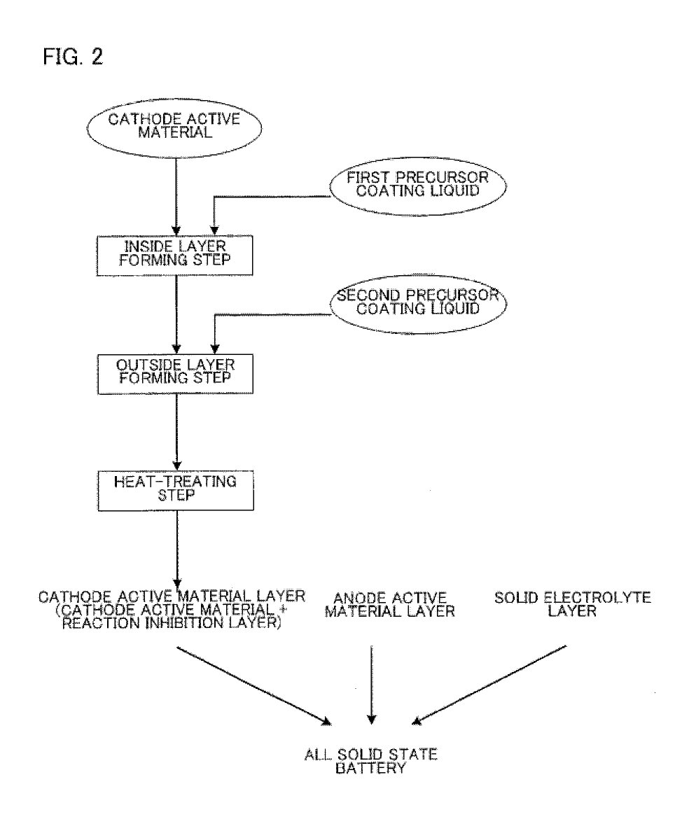

FIG. 2 is a flow chart explaining an example of the producing method of the all solid state battery of the present invention. In FIG. 2, the inside layer is formed by coating and drying the first precursor coating liquid containing a raw material for the first lithium ion conductor on the surface of the cathode active material (inside layer forming step). Next, the outside layer is formed by coating and drying the second precursor coating liquid containing a raw material for the second lithium ion conductor on the surface of the above-mentioned inside layer (outside layer forming step). Subsequently, the inside layer and the outside layer are heat-treated to form the reaction inhibition portion (heat-treating step). Thus, the cathode active material on whose surface the reaction inhibition portion containing the first lithium ion conductor and the second lithium ion conductor is formed may be formed. Also, the all solid state battery comprising the cathode active material layer using the above-mentioned cathode active material, the anode active material layer and the solid electrolyte layer is obtained.

According to the present invention, the above-mentioned coating liquid is coated on the surface of the cathode active material or on the inside layer, and dried so that the coating liquids do not react with each other to thereby form each of the inside layer and the outside layer, and thereafter both of the layers are heat-treated together, so that the reaction inhibition portion in which the first lithium ion conductor and the second lithium ion conductor are uniformly dispersed may be formed simply and easily. Thus, interface resistance between the cathode active material and the sulfide solid electrolyte material may be inhibited from increasing with time, and the all solid state battery excellent in Li ion conductivity and durability may be produced simply and easily.

Conventionally, examples of the forming method for the reaction inhibition portion include a sol-gel method. The sol-gel method is a method for forming the reaction inhibition portion in such a manner that a coating liquid obtained by dissolving or dispersing a forming material for the reaction inhibition portion in a solvent is coated and thereafter heat-treated. However, in the case where the formation of the reaction inhibition portion containing two kinds of compounds, namely, the first lithium ion conductor and the second lithium ion conductor is attempted by using such a sol-gel method, there is a possibility that a component contained in each of the coating liquids reacts with each other in coating the coating liquid containing a raw material for each of the compounds. Thus, the reaction inhibition portion containing two kinds of intended compounds is occasionally formed with difficulty.

On the contrary, in the present invention, the inside layer is first formed by coating and drying either one coating liquid of the first precursor coating liquid containing a raw material for the first lithium ion conductor and the second precursor coating liquid containing a raw material for the second lithium ion conductor on the surface of the cathode active material, and thereafter the outside layer is formed by coating and drying the other coating liquid. The formation of each of the inside layer and the outside layer by drying allows a component contained in each of the coating liquids to be inhibited from reacting with each other. Also, the formed inside layer and outside layer are heat-treated together, so that convection is caused between both of the layers, and the reaction inhibition portion in which the first lithium ion conductor and the second lithium ion conductor are uniformly dispersed may be formed. Thus, interface resistance between the cathode active material and the sulfide solid electrolyte material may be inhibited from increasing with time, and the all solid state battery excellent in Li ion conductivity and durability may be produced simply and easily.

Incidentally, the anode active material layer and the solid electrolyte layer in the present invention are the same as the contents described in the item of the above-mentioned “A. All solid state battery”; therefore, the description herein is omitted.

The method for producing the all solid state battery of the present invention is hereinafter described in each step.

1. Inside Layer Forming Step

First, the inside layer forming step in the present invention is described. The inside layer forming step in the present invention is a step of forming the inside layer by coating and drying one coating liquid of the first precursor coating liquid containing a raw material for the first lithium ion conductor and the second precursor coating liquid containing a raw material for the second lithium ion conductor on the surface of the above-mentioned cathode active material. Here, the first precursor coating liquid and the second precursor coating liquid used for the present step are ordinarily sol-gel solutions such as to be made into a sol state by hydrolysis and polycondensation reaction of a compound as a raw material for the ion conductor contained therein, and made into a gel state by progress of polycondensation reaction and aggregation.

(1) First Precursor Coating Liquid

The first precursor coating liquid in the present step contains a raw material for the first lithium ion conductor. The raw material for the first lithium ion conductor contained in the first precursor coating liquid in the present step is not particularly limited if the material is such as to allow the intended first lithium ion conductor to be formed. Examples of the first lithium ion conductor include the same as is described in the item of the above-mentioned “A. All solid state battery”; above all, in the present invention, the first lithium ion conductor is preferably LiNbO₃. A Li-feeding compound and an Nb-feeding compound may be used as a raw material for LiNbO₃. Examples of the Li-feeding compound include Li alkoxide such as ethoxylithium and methoxylithium, and lithium salt such as lithium hydroxide and lithium acetate. Also, examples of the Nb-feeding compound include Nb alkoxide such as pentaethoxyniobium and pentamethoxyniobium, and niobium salt such as niobium hydroxide and niobium acetate. Incidentally, the concentration of the raw material for the first lithium ion conductor contained in the first precursor coating liquid is properly determined in accordance with the composition of the intended reaction inhibition portion.

In the present step, the first precursor coating liquid may be ordinarily obtained by dissolving or dispersing the raw material for the first lithium ion conductor in a solvent. The solvent used for the first precursor coating liquid is not particularly limited if the solvent is such as to allow the raw material for the first lithium ion conductor to be dissolved or dispersed and such as not to deteriorate the above-mentioned raw material for the first lithium ion conductor, but examples thereof include ethanol, propanol and methanol. Also, the above-mentioned solvent is preferably small in moisture amount from the viewpoint of inhibiting the above-mentioned raw material from being deteriorated. Incidentally, the first precursor coating liquid used for the present step may contain an optional addition agent as required.

(2) Second Precursor Coating Liquid

The second precursor coating liquid in the present step contains a raw material for the second lithium ion conductor. The raw material for the second lithium ion conductor contained in the second precursor coating liquid used for the present step is not particularly limited if the material is such as to allow the second lithium ion conductor to be formed.

The raw material for the second lithium ion conductor is not particularly limited if the material is such as to allow an intended Li-containing compound to be formed, but examples thereof include hydroxide, oxide, metal salt, metal alkoxide and metal complex. Incidentally, in the present invention, a previously synthesized compound may be used as the raw material for the second lithium ion conductor. Here, as described in the item of the above-mentioned “A. All solid state batter’”, the second lithium ion conductor is an Li-containing compound provided with a polyanion structural portion having at least one of B, Si, P, Ti, Zr, Al and W. Also, the polyanion structural portion comprises at least one kind of element among the above-mentioned elements and plural oxygen elements. Thus, the second lithium ion conductor may be represented by a general formula LiₓAO_{y} (A is at least one kind of B, Si, P, Ti, Zr, Al and W, and “x” and “y” are positive numbers), for example.

Also, with regard to the raw material for the second lithium ion conductor, in the above-mentioned general formula LiₓAO_{y} of the Li-containing compound, in the case where A is a metallic element, for example, Li alkoxide such as ethoxylithium and methoxylithium, and lithium salt such as lithium hydroxide and lithium acetate are used as the Li-feeding compound, and metal oxide, metal salt and metal complex containing the above-mentioned A are used as an A-feeding compound. For example, in the case where the above-mentioned Li-containing compound is Li₂Ti₂O₅, ethoxylithium of the Li-feeding compound and tetraisopropoxytitanium of a Ti-feeding compound may be used as the raw material. On the other hand, in the above-mentioned general formula of the Li-containing compound, in the case where the A element is a nonmetal, for example, an intended Li-containing compound may be directly used. For example, in the case where the above-mentioned Li-containing compound is Li₃PO₄, Li₃PO₄ may be used as the raw material for the second lithium ion conductor. Also, in the above-mentioned general formula of the Li-containing compound, in the case where A is B (boron), the above-mentioned Li-feeding compound and boric acid as a B-feeding compound may be used as the raw material for the second lithium ion conductor. Incidentally, an O-feeding compound of the above-mentioned Li-containing compound may be the raw material for the second lithium ion conductor, or water contained in the second precursor coating liquid in the present invention.

The content of the raw material for the second lithium ion conductor contained in the second precursor coating liquid in the present invention is properly selected in accordance with the intended reaction inhibition portion.

In the present step, similarly to the above-mentioned first precursor coating liquid, the second precursor coating liquid may be obtained by dissolving or dispersing the raw material for the second lithium ion conductor in a solvent. The solvent used for the second precursor coating liquid is not particularly limited if the solvent is such as to allow the raw material for the second lithium ion conductor to be dissolved or dispersed and such as not to deteriorate the above-mentioned compound, but examples thereof include ethanol, propanol and methanol. Incidentally, the second precursor coating liquid used for the present step may contain an optional addition agent as required.

(3) Inside Layer Forming Step

The thickness of the inside layer formed by the present step is properly determined in accordance with the thickness of the intended reaction inhibition portion and other factors; for example, preferably within a range of 1 nm to 500 nm, more preferably within a range of 2 nm to 100nm, and particularly preferably within a range of 2 nm to 10 nm.

A publicly known coating method may be used as the method for coating the above-mentioned first precursor coating liquid or second precursor coating liquid on the surface of the cathode active material in the present step, and examples thereof include a spin coat method, a dip coat method, a spray coat method and an impregnation method.

The present step may inhibit a component contained in the inside layer from reacting with a component contained in the other coating liquid used for the after-mentioned outside layer forming step by reason of drying either one coating liquid of the above-mentioned first precursor coating liquid and second precursor coating liquid after coating to remove a solvent contained in the coating liquid. Also, a general method may be used as the method for drying the coating liquid coated on the surface of the cathode active material.

2. Outside Layer Forming Step

Next, the outside layer forming step in the present invention is described. The outside layer forming step in the present invention is a step of forming an outside layer by coating and drying the other coating liquid of the above-mentioned first precursor coating liquid and the above-mentioned second precursor coating liquid on the surface of the above-mentioned inside layer. Incidentally, the first precursor coating liquid and the second precursor coating liquid used for the present step are the same as the contents described in the above-mentioned inside layer forming step; therefore, the description herein is omitted.

The thickness of the outside layer formed by the present step is, for example, preferably within a range of 1 nm to 500 nm, more preferably within a range of 2 nm to 100 nm, and particularly preferably within a range of 2 nm to 10 nm.

The same method as the above-mentioned inside layer forming step may be used for the coating method for the precursor coating liquid used for the present step. Also, the present step dries the precursor coating liquid after coating, similarly to the above-mentioned inside layer forming step. Thus, the removal of a solvent contained in the coating liquid allows the reaction inhibition portion to be efficiently formed in the after-mentioned heat-treating step. A general method may be used as the drying method in the present step, similarly to the above-mentioned inside layer forming step.

3. Heat-Treating Step

Next, the heat-treating step in the present invention is described. The heat-treating step in the present invention is a step of heat-treating the above-mentioned inside layer and outside layer to form the reaction inhibition portion. In the present step, the heat treatment of the above-mentioned inside layer and outside layer allows the reaction inhibition portion, in which the first lithium ion conductor and the second lithium ion conductor contained in the inside layer and the outside layer are uniformly dispersed, to be formed.

The heat-treating temperature in the present step is, for example, preferably within a range of 150° C. to 600° C., more preferably within a range of 200° C. to 500° C., and particularly preferably within a range of 300° C. to 400° C. The reason therefor is that the case where the above-mentioned heat-treating temperature is less than the above-mentioned range brings a possibility that the first lithium ion conductor and the second lithium ion conductor are not sufficiently uniformized by the heat treatment, while the case where the above-mentioned heat-treating temperature exceeds the above-mentioned range brings a possibility of deteriorating the reaction inhibition portion and the cathode active material.

The heat-treating time in the present step is, for example, preferably within a range of 0.5 hour to 10 hours, and more preferably within a range of 3 hours to 7 hours. The reason therefor is that the case where the above-mentioned heat-treating time is less than the above-mentioned range brings a possibility that the first lithium ion conductor and the second lithium ion conductor are not sufficiently uniformized by the heat treatment, while the case where the above-mentioned heat-treating time exceeds the above-mentioned range brings a possibility that the reaction inhibition portion and the cathode active material are excessively heat-treated and deteriorated.

The heat treatment atmosphere in the present step is not particularly limited if the atmosphere is such as to allow the intended reaction inhibition portion to be formed and not such as to deteriorate the reaction inhibition portion and the cathode active material, but examples thereof include air atmosphere; inert gas atmosphere such as nitrogen atmosphere and argon atmosphere; reducing atmosphere such as ammonia atmosphere, hydrogen atmosphere and carbon monoxide atmosphere; and vacuum.

4. Other Steps

The present invention is not particularly limited if the present invention has the above-mentioned steps, but, in the case where the cathode active material used for the present invention is in a particulate shape, examples thereof include a cathode active material layer forming step of forming the cathode active material layer by pressing a material composing the cathode active material layer, such as the cathode active material on whose surface the reaction inhibition portion is formed by the above-mentioned step, with a pressing machine, a solid electrolyte layer forming step of forming the solid electrolyte layer by pressing a material composing the solid electrolyte layer similarly, and an anode active material layer forming step of forming the anode active material layer by pressing a material composing the anode active material layer similarly. Also, in the case where the cathode active material is in a thin-film shape, examples thereof include a solid electrolyte layer forming step of laminating a material composing the solid electrolyte layer on the cathode active material on whose surface the reaction inhibition portion is formed by the above-mentioned step, and an anode active material layer forming step of laminating a material composing the anode active material layer on the solid electrolyte layer.

Also, the present invention may have as other steps, a step of disposing the cathode current collector on the surface of the cathode active material layer, a step of disposing the anode current collector on the surface of the anode active material layer, and a step of storing the power generating element in the battery case. Incidentally, the cathode current collector, the anode current collector and the battery case are the same as the contents described in the item of the above-mentioned “A. All solid state battery”; therefore, the description herein is omitted.

Incidentally, the present invention is not limited to the above-mentioned embodiments. The above-mentioned embodiments are exemplification, and any is included in the technical scope of the present invention if it has substantially the same constitution as the technical idea described in the claim of the present invention and offers similar operation and effect thereto.

### Examples

The present invention is described more specifically while showing examples hereinafter.

### Example

(Preparation of First Precursor Coating Liquid)

In 20 ml of ethanol (manufactured by Wako Pure Chemical Industries, Ltd.), 1 mmol of ethoxylithium (manufactured by Kojundo Chemical Lab. Co., Ltd.) and 1 mmol of pentaethoxyniobium (manufactured by Kojundo Chemical Lab. Co., Ltd.) were mixed to obtain a first precursor coating liquid.

(Preparation of Second Precursor Coating Liquid)

In 20 ml of ethanol (manufactured by Wake Pure Chemical Industries, Ltd.), 1 mmol of ethoxylithium (manufactured by Kojundo Chemical Lab. Co., Ltd.) and 1 mmol of tetraisopropoxytitanium (manufactured by Kojundo Chemical Lab. Co., Ltd.) were mixed to obtain a second precursor coating liquid.

(Formation of Reaction Inhibition Portion)

A lithium cobaltate thin film (a cathode active material) was obtained on an Au substrate by sputtering. The first precursor coating liquid was coated (5000 rpm, 10 sec) and dried on the lithium cobaltate thin film by using a spin coater (MS-A100™, manufactured by Mikasa, Co., Ltd.) to form an inside layer. Thereafter, the second precursor coating liquid was coated (5000 rpm, 10 sec) and dried to form an outside layer. Next, the inside layer and the outside layer were heat-treated (350° C., 0.5 hour) to form a reaction inhibition portion and then obtain an electrode having the cathode active material on whose surface the reaction inhibition portion was formed.

(Production of All Solid State Battery)

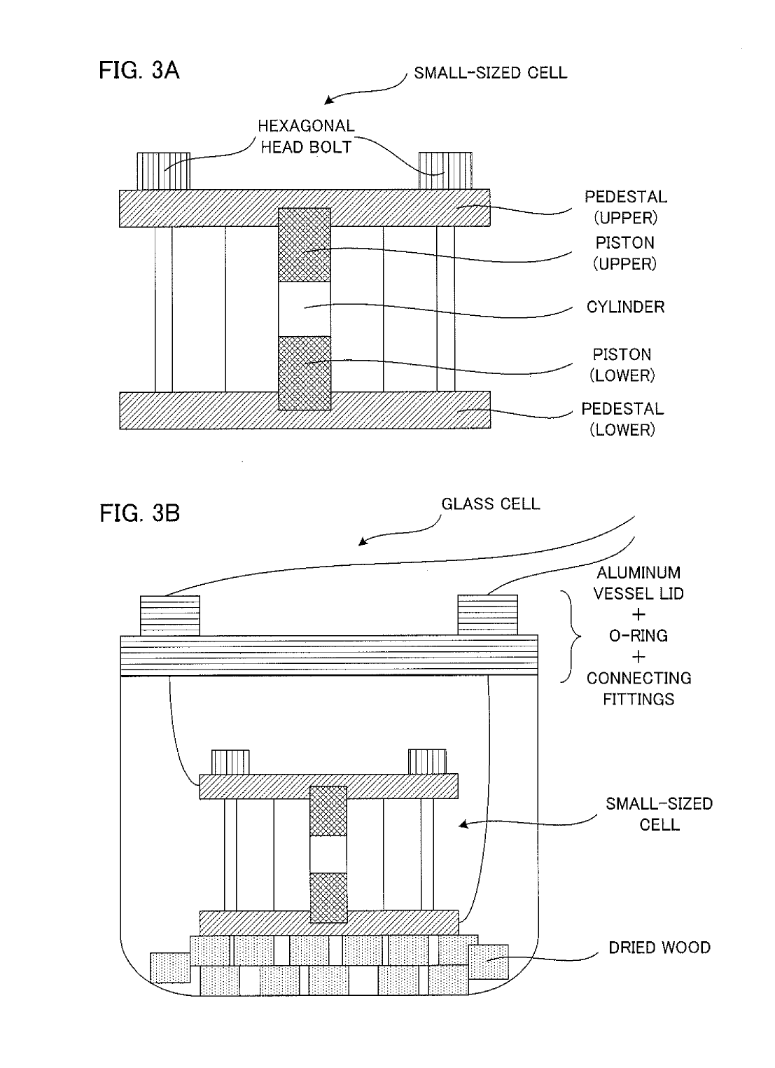

Into a cylinder in a small-sized cell as shown in FIG. 3A, 50 mg of 75Li₂S-25P₂S₅ was projected and pressed (1.0 t/cm², 1 min) by upper and lower pistons while leveled evenly with a spatula to form a solid electrolyte layer. Next, the above-mentioned electrode was pressed similarly (4 t/cm², 1 min) on the solid electrolyte layer to form a cathode active material layer. Subsequently, a Li—In foil was pressed similarly (1.0 t/cm², 1 min) on the opposite face to the face on which the cathode active material layer of the solid electrolyte layer was formed to form an anode active material layer and then obtain a power generating element. Next, after fastening the bolt of the small-sized cell, the wiring was connected to produce an all solid state battery by assembling after putting a drying agent in a glass cell as shown in FIG. 35.

### Evaluation 1

(TEM Observation)

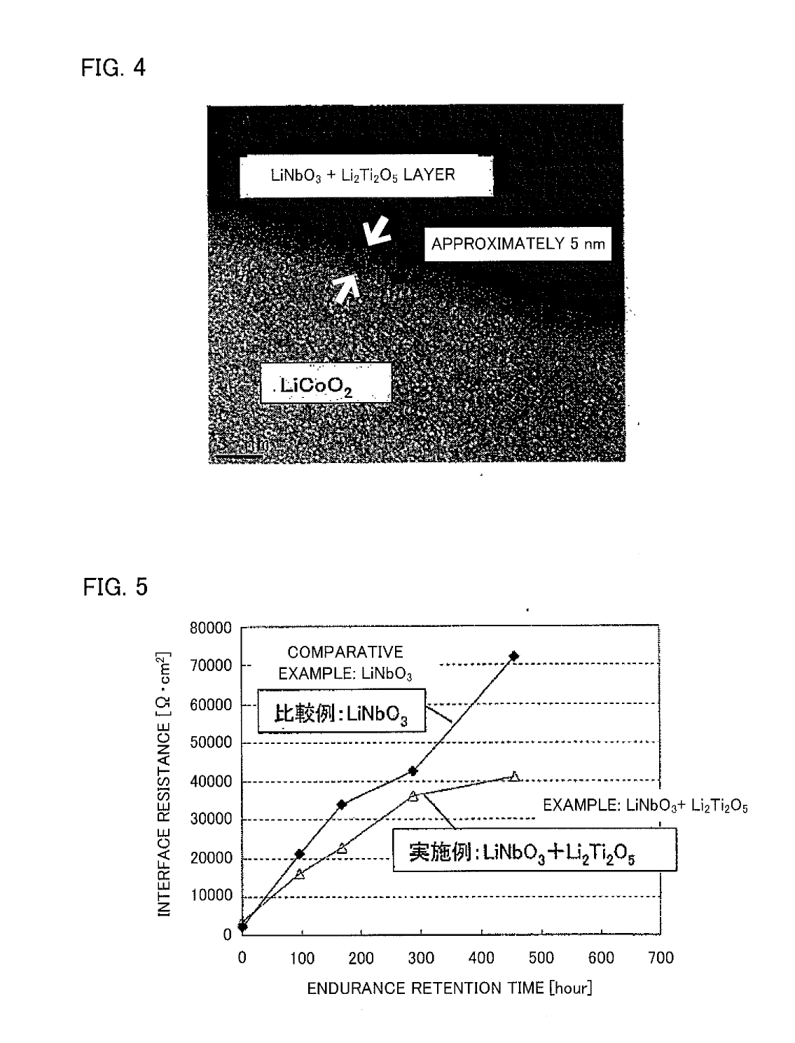

The cross section of the electrode of the all solid state battery produced in Example was observed with a transmission electron microscope (TEM). The results are shown in FIG. 4. As shown in FIG. 4, the reaction inhibition portion formed on the lithium cobaltate as the cathode active material was confirmed. Also, it may be confirmed through the results of the TEM image that the thickness of the reaction inhibition portion was approximately 5 nm.

### Comparative Example

(Preparation of Coating Liquid)

In 10 ml of ethanol (manufactured by Wako Pure Chemical Industries, Ltd.), 1 mmol of ethoxylithium (manufactured by Kojundo Chemical Lab. Co., Ltd.) and 1 mmol of pentaethoxyniobium (manufactured by Kojundo Chemical Lab. Co., Ltd.) were mixed to obtain a first precursor coating liquid. Next, an all solid state battery was obtained in the same manner as Example except for coating only the first precursor coating liquid on the lithium cobaltate thin film.

### Evaluation 2

(Interface Resistance Measurement)

The interface resistance was measured by using the all solid state battery obtained in Example and Comparative Example. First, after adjusting the electric potential of the all solid state battery to 3.58 V, the interface resistance of the all solid state battery was calculated by performing complex impedance measurement. Incidentally, the interface resistance was calculated from the diameter of the circular arc of the impedance curve. Thereafter, the all solid state battery was preserved at a temperature of 60° C. to calculate the interface resistance of the all solid state battery after being preserved and then measure a change in the interface resistance with time. The results are shown in FIG. 5.

As shown in FIG. 5, with regard to Example, it may be confirmed that the interface resistance was inhibited from increasing with time as compared with Comparative Example. As in Comparative Example, in the case where the reaction inhibition portion was composed of only LiNbO₃, the interface resistance was inhibited from increasing at the initial stage, but it is conceived that an increase in the interface resistance became gradually remarkable for the reason that LiNbO₃ reacted with the sulfide solid electrolyte material to change the structure of the reaction inhibition portion. On the contrary, as Example, in the case where the reaction inhibition portion was composed of two kinds of Li-containing compounds, it is conceived that the interface resistance was inhibited from increasing with time for the reason that the structure of the reaction inhibition portion may be inhibited from changing due to a reaction with the sulfide solid electrolyte material in contacting therewith.

### REFERENCE SIGNS LIST

1 Cathode active material layer

2 Anode active material layer

3 Solid electrolyte layer

4 Cathode active material

5 Sulfide solid electrolyte material

6 Reaction inhibition portion

10 Power generating element

1-4. (canceled)

5. An all solid state battery comprising a cathode active material layer containing a cathode active material, an anode active material layer containing an anode active material, and a solid electrolyte layer formed between the cathode active material layer and the anode active material layer,
wherein at least one of the cathode active material layer and the solid electrolyte layer contains a sulfide solid electrolyte material;
a reaction inhibition portion containing a first lithium ion conductor and a second lithium ion conductor is formed on a surface of the cathode active material;
the first lithium ion conductor is LiNbO₃; and
the second lithium ion conductor is an Li-containing compound provided with a polyanion structural portion having at least one of Ti and Zr.

6. The all solid state battery according to claim 5, wherein the second lithium ion conductor is Li₂Ti₂O₅, Li₂Ti₂O₃, Li₄Ti₅O₁₂, or Li₂ZrO₃.

7. A method for producing the all solid state battery, the all solid state battery comprises a cathode active material layer containing a cathode active material, an anode active material layer containing an anode active material, and a solid electrolyte layer formed between the cathode active material layer and the anode active material layer, in which at least one of the cathode active material layer and the solid electrolyte layer contains a sulfide solid electrolyte material; a reaction inhibition portion containing a first lithium ion conductor and a second lithium ion conductor is formed on a surface of the cathode active material; the first lithium ion conductor is LiNbO₃; and the second lithium ion conductor is an Li-containing compound provided with a polyanion structural portion having at least one of B, Si, P, Ti, Zr, Al, and W;
wherein the method comprises steps of:
an inside layer forming step of forming an inside layer by coating and drying one coating liquid of a first precursor coating liquid containing a raw material for the first lithium ion conductor and a second precursor coating liquid containing a raw material for the second lithium ion conductor on the surface of the cathode active material;
an outside layer forming step of forming an outside layer by coating and drying the other coating liquid of the first precursor coating liquid and the second precursor coating liquid on a surface of the inside layer; and
a heat-treating step of heat-treating the inside layer and the outside layer to form the reaction inhibition portion.
